(19) United States
(12) Patent Application Publication
(10) Pub. No.: US 2010/0132110 A1
(43) Pub. Date: Jun. 3, 2010

(54) BIMETAL LAMINATE STRUCTURE AND METHOD OF MAKING THE SAME

(75) Inventor: James R. Schwaegler, Canton, MI (US)

Correspondence Address: QUINN LAW GROUP, PLLC, 39555 ORCHARD HILL PLACE, SUITE # 520, NOVI, MI, 48375, US

(73) Assignee: MATERIAL SCIENCES CORPORATION, Elk Grove Village, IL (US)

(21) Appl. No.: 12/325,407

(22) Filed: Dec. 1, 2008

(51) Int. Cl. E03C 1/04; B32B 15/00; B32B 37/00; A47K 1/00

(52) U.S. Cl. 4/619; 428/615; 156/60; 156/242

(57) ABSTRACT

Bimetal laminate structures and an improved method for manufacturing the same are provided herein. In one preferred embodiment, the laminate structure includes a first constraining layer that is fabricated from a metallic material, such as stainless steel. A second constraining layer that is appreciably thicker than the first is also included. The second constraining layer is fabricated from a different metallic material, such as low-carbon cold rolled steel. An adhesive layer spans between and rigidly bonds the first and second constraining layers. The first and second constraining layers have a thickness ratio, a yield strength ratio, and a springback ratio that are collectively optimized such that the laminate structure can be formed, preferably through a deep drawing operation, to define one or more depressions/basins of a predetermined depth without delaminating or cracking. The adhesion strength of the adhesive layer is also engineered to prevent separation of the two constraining layers.

### TECHNICAL FIELD

The present invention relates generally to laminated metal structures. More particularly, the present invention relates to metal-polymer-metal laminate containers and methods of making the same.

### BACKGROUND OF THE INVENTION

Containers used as wash sinks (commonly referred to as “sink bowls” or “sink basins”) are traditionally formed from a single-layered sheet of metallic material, such as stainless steel. Sink bowls made from cast ceramic, acrylic, iron, polymeric, and other materials are also known. However, sink bowls made from stainless steel provide excellent durability in comparison to their conventional counterparts. Stainless steel sinks, for example, are less prone to cracking and chipping, minimize unwanted metal oxidation (i.e., rust), and reduce the buildup of surface microorganisms. As such, stainless steel sinks are often used in harsh working environments and sterile environments that sinks made from other materials would be otherwise unsuitable for.

Seamless single- and double-bowl sink configurations (i.e., single-piece sink designs with a single bowl or two adjacent bowls) have traditionally been formed by deep drawing the sink from a lone stainless steel sheet blank. Generally, such methods for forming single- or double-bowl sinks involve clamping a stainless steel blank in a double action press. The bowl is formed in one or more draws by applying a force to a forming die which contacts the clamped blank and forces it through a drawing die. For single deep-drawn sink bowls, more than one draw is frequently required, and partially formed bowls are often stock-piled between the first and subsequent forming steps. Double-bowl sink configurations require a number of drawing steps, and the partially formed blanks are also stock-piled between forming steps.

In addition to the abovementioned functional characteristics, stainless steel sink bowls also offer aesthetic characteristics, often used to compliment certain kitchen designs and work surroundings. For instance, a stainless steel sink can be provided with a surface refinement or “appearance finish”, which may include shining, glazing, texturing, brushing, embossing, varnishing, polishing, staining, clear coating, etc. However, the use of monolithic stainless steel sheets to fabricate the wash sink may be limited due to the high cost of the material (primarily the nickel content).

Some prior art attempts have been made to mitigate the cost of using certain monolithic metal substrates to fabricate wash sinks. One proposal is to reduce the thickness (i.e., “gauge”) of the monolithic panel and, thus, the total volume of material being used. However, reducing the thickness of the monolithic metal panel may lead to reduced robustness, such as degraded structural and surface integrity. In addition, at a certain point, the decreased thickness will reduce formability of the sheet metal blank, limiting draw depth and restricting shaping options. Such reduced thicknesses will also eliminate use of certain post processing operations, such as brushing, polishing, embossing, or other decorative finishes imparted by mechanical means, due to minimal thickness requirements.

Another proposal has been to use electroplating, electrodeposition, and other similar processes to coat a substrate of lesser expensive metal with a film of the more expensive metallic material. Unfortunately, the electroplated surface will read through (or telegraph) the appearance of the substrate surface to which it is coating. Moreover, the extremely thin metal layer produced by electroplating has a limited operational life expectancy, is expensive to produce, and is prone to damage from certain post processing operations.

It has also been proposed to “metalize” one surface of a polymeric panel to create the desired wash sink configuration with a utility-side stainless steel surface. However, the peel strength of the metal-film on the polymer is often insufficient for many processing and post-processing operations, leaving the metal-film layer susceptible to delamination. The mechanical stresses generated when first forming the metal on the polymeric substrate, and in subsequent processing steps, can cause the metal-film to distort or flex, which may cause the metal to bubble on and/or peel away from the polymer substrate. In addition, metalized-polymer structures do not have the same chemical resistance or scratch resistance as solid metal structures, and cannot be easily repaired when scratching, staining, etc., occurs.

### SUMMARY OF THE INVENTION

The present invention discloses a family of bimetal laminate structures, and an improved method of manufacturing the same. In one exemplary embodiment, the metal-polymer-metal laminate structure is formed into a wash sink configuration through a deep forming operation. By identifying, designing, and controlling certain specific variables in the properties of the metal-polymer-metal laminate, this invention allows for the successful formability of a very deep, less expensive, single-piece, seamless, continuous container with a durable stainless steel surface. For instance, by constructing a bimetal laminate as a means of maintaining a durable stainless steel wash sink surface, the remaining thickness can be supported by a significantly less expensive, corrosion protected low-carbon sheet steel structure.

According to one embodiment of the present invention, a laminate structure is presented. The laminate structure includes first and second constraining layers. The first constraining layer is formed, at least partially, from a first metallic material, whereas the second constraining layer is formed, at least partially, from a second metallic material that is different from the first metallic material. Ideally, the first constraining layer is stainless steel and the second constraining layer is a low-carbon steel. In addition, the first constraining layer has a first thickness, and the second constraining layer has a thickness that is greater than the first thickness. An adhesive layer bonds the first and second constraining layers together.

The first and second constraining layers have certain properties, such as a springback ratio, a thickness ratio, and a yield strength ratio, that are individually or collectively optimized such that the laminate structure can be formed to define a depression of a predetermined depth, such as a sink bowl, without delaminating, either partially or in its entirety. Additionally, the adhesion strength of the adhesive layer is also engineered to prevent separation of the two constraining layers.

According to one aspect of this particular embodiment, the springback ratio between the first and second constraining layers is approximately 1:8.5.

In another aspect of the present embodiment, the thicknesses ratio between the first and second constraining layers is approximately 1:4.8.

In accordance with yet another aspect, the yield strength ratio between the first and second constraining layers is approximately 1:0.6.

According to yet another aspect, the adhesive layer has an adhesive strength of 1200 pounds per square inch (psi) or greater.

As part of another aspect of this embodiment, the predetermined total depth of the depression formed in the laminate structure is at least six inches. To this regard, the total thickness of the laminate structure is preferably less than 0.05 inches.

In an additional aspect, the first constraining layer is characterized by a surface with an appearance finish, whereas the second constraining layer is characterized by the absence of a surface with an appearance finish. As used herein, the term “appearance finish” should be defined or interpreted to indicate a surface refinement such as, but certainly not limited to, a shine, glaze, texturing, varnish, polish, brushing, staining, or topical treatment, or any combination thereof.

According to another embodiment of the present invention, a wash sink is provided. The wash sink includes a laminate panel having a base or bottom with a plurality of sidewalls that extend upward therefrom to collectively define at least one bowl or basin. The laminate panel comprises a utility layer, a substrate layer, and an at least one adhesive layer. The utility later has a first thickness, and is at least partially composed of stainless steel. The substrate layer has a second thickness that is greater than the first thickness, and is at least partially composed of low-carbon cold rolled steel. The adhesive layer is disposed between and spans substantially the entirety of the utility layer and substrate layer to rigidly attach the same. The utility and substrate layers have a thickness ratio, a yield strength ratio, and a springback ratio that are collectively modified, engineered, selected or otherwise optimized to eliminate delamination of the laminate panel.

According to one aspect of this embodiment, the springback ratio is approximately 1:8.54.

According to another aspect of this embodiment, the yield strength ratio is approximately 1:0.56.

According to yet another aspect, the thicknesses ratio is approximately 1:4.75.

As part of yet another aspect, the adhesive strength of the adhesive layer is at least 1200 psi.

In one additional aspect, the utility layer is approximately 0.008 inches thick, the substrate layer is approximately 0.038 inches thick, and the adhesive layer is approximately 0.001 inches thick.

As part of another embodiment of the present invention, a method of manufacturing a wash sink is presented. The method comprises an array of steps, such as first applying a layer of adhesive to a first constraining layer, a second constraining layer, or both. The first constraining layer, which is at least partially composed of stainless steel, has a first thickness, whereas the second constraining layer, which is at least partially composed of cold rolled steel, has a second thickness that is greater than the first thickness. The next step includes laminating the first constraining layer to the second constraining layer to form a one-piece laminate panel. Thereafter, the method includes forming the laminate panel, preferably through deep drawing, to include at least one basin or bowl with a predetermined depth. The first and second constraining layers have a thickness ratio, yield strength ratio, and springback ratio that are engineered, along with the adhesion strength of the adhesive layer, to thereby eliminate substantially all cracking and delamination of the laminate panel during forming of the basin(s).

The above features and advantages, and other features and advantages of the present invention will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a perspective view illustration of an exemplary wash sink configuration integrally formed from a metal-polymer-metal laminate structure in accordance with the present invention;

FIG. 2 is a cross-sectional illustration of the wash sink of FIG. 1 taken along line 2-2;

FIG. 3 is a graphical representation of the stress versus strain curves for the two constraining layers of the laminate structure from FIGS. 1 and 2;

FIG. 4 is a graphical representation of the relationship between thickness ratio and springback force for the two constraining layers of the laminate structure from FIGS. 1 and 2;

FIG. 5 is a graphical representation of the required adhesive strength to overcome various springback force ratios for the two constraining layers of the laminate structure from FIGS. 1 and 2; and

FIG. 6 is a graphical representation of the maximum thickness ratio for the two constraining layers of the laminate structure from FIGS. 1 and 2 to achieve various draw depths.

### DESCRIPTION OF THE PREFERRED EMBODIMENT

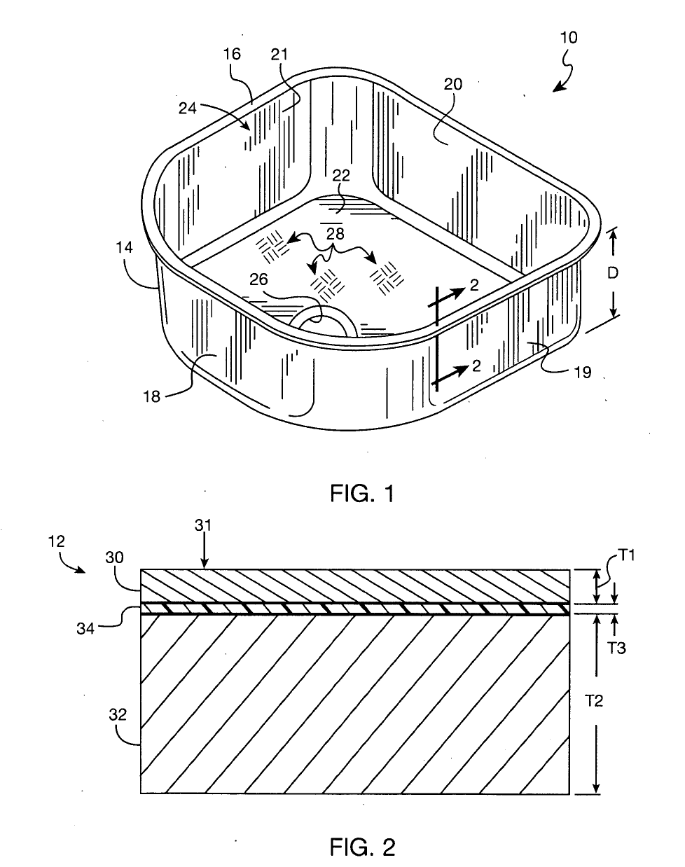

Referring to the drawing, wherein like reference numbers refer to like elements throughout the several views, FIG. 1 illustrates a representative wash sink configuration, indicated generally therein at 10, that is integrally formed from a metal-polymer-metal laminate structure, designated generally at 12 in FIG. 2, in accordance with the present invention. The embodiments of the present invention will be described herein with respect to the wash sink 10, which is intended solely as an exemplary application by which the present invention may be utilized and practiced. Accordingly, the present invention is by no means to be limited to the particular configuration of FIG. 1. To that extent, the present invention can be applied to other containers and wash sink configurations without departing from the intended scope of the claimed invention. In addition, the drawings presented herein are not to scale, and are provided purely for instructional purposes. Thus, the specific and relative dimensions shown in the drawings are not to be considered limiting.

With continuing reference to FIG. 1, the wash sink 10 includes a bowl portion 14 with a support rim 16 that extends orthogonally from the upper edge thereof, elongated continuously around the periphery of the bowl opening. A plurality of interconnected sidewalls, such as first, second, third and fourth sidewalls 18, 19, 20 and 21, respectively, extend upward from and cooperate with a base or floor 22 to define a bowl 24 (also referred to herein as a “depression” or “basin”). A drain opening 26 is formed through the base 22 of the bowl 24, and is preferably adapted to be connected to a drain pipe (not explicitly illustrated herein). It should be recognized that the shape and size of the bowl 24 can be varied to meet the particular needs of the intended application of the wash sink 10. Moreover, the wash sink 10 can be fabricated with an array of integrally formed, juxtaposed sink bowls of identical or differing designs within the scope and spirit of the present invention.

In accordance with the present invention, the wash sink 10 is a seamless, one-piece, continuous structure that is integrally formed from a metal-polymer-metal laminate 12, which is more clearly portrayed in FIG. 2. The metal-polymer-metal laminate 12 (also referred to herein as “bimetal laminate” or “laminate panel”) is a laminated sheet structure, which includes a first constraining layer 30 (or “utility layer”) and a second constraining layer 32 (or “substrate layer”). An adhesive layer 34 is disposed between and spans the entirety of (i.e., is coextensive with) the first constraining layer 30 and the second constraining layer 32. The adhesive layer 34 acts to rigidly attach and bond the first and second constraining layers 30, 32 together. Notably, the laminate structure 12 may include additional substrate layers, additional adhesive layers, and various other additional layers (e.g., an electro-galvanized coating, dichromate paint, zinc plating, etc.) without departing from the intended scope of the present invention.

The first constraining layer 30 is intended to provide a durable, rust-resistant wash surface, while the remaining thickness thereof is supported by the second constraining layer 32, which acts as a low cost, preferably corrosion protected, structural substratum. The first constraining layer 30 is formed, at least partially, from a first metallic material, whereas the second constraining layer 32 is formed, at least partially, from a second metallic material that is different from the first metallic material. In one preferred embodiment, the first constraining layer 30 is fabricated from stainless steel, such as 430 stainless steel alloy, 304(L) stainless steel alloy in an annealed condition, or austenitic stainless steel, for example 316 stainless steel. The second constraining layer 32, on the other hand, is formed from high strength, low cost metal sheet stock, which may include, but is not limited to, electro-galvanized steel, hot-dip galvanized steel, tin free steel, and tin mill black plate steel, but is preferably a low-carbon, cold rolled steel.

The first constraining layer 30 may be adapted as a show surface and, thus, may be characterized by an outer surface 31 with an appearance finish. Conversely, the metallic substrate layer 32 is considered a “b-side” surface, and thus is preferably characterized by the absence of an outer show surface with an appearance finish. As used herein, the term “appearance finish” should be defined or interpreted to indicate a surface refinement such as, but not limited to, a shine, glaze, texturing, varnish, polish, staining, clear coating, or topical treatment, all of which are represented collectively in FIG. 1 by brushing 28.

The layer of adhesive 34 consists of those adhesives, whether natural or synthetic, which provide sufficient bonding strength to adhere the two constraining layers 30, 32 together, and sufficient resiliency to withstand the manufacturing environment and post processing operations for fabricating the laminate structure 12. Purely by way of example, the layer of adhesive 34 may be a cold-forming PSA acrylic adhesive, dry-bond adhesive, such as polyester urethanes, and the like.

The first constraining layer 30 has a first thickness T1, the second constraining layer 32 has a second thickness T2, and the intermediate adhesive layer 34 has a third thickness T3. As seen in FIG. 2, the thickness T2 of the second constraining layer 32 is appreciably larger than the thickness T1 of the first constraining layer 30. By way of example, and certainly not limitation, the wash sink utility layer 30 has a thickness T1 of approximately 0.203 millimeters (0.008 inches). In contrast, the wash sink substrate layer 32 has a preferred thickness T2 of approximately 0.965 millimeters (0.038 inches). The layer of adhesive 34 has a preferred thickness T3 of approximately 0.025 millimeters (0.001 inches). The overall laminate thickness of the laminate structure 12 is preferably less than 1.280 mm (0.50 inches). In the embodiment of FIG. 2, for example, the sum total thickness of T1, T2, and T3, is approximately 1.194 mm (0.048 inches). Likewise, the total depth D of the wash sink bowl portion 14 (FIG. 1) is at least 152 mm (approximately six inches).

The present invention allows for the successful forming of a very deep, single-piece, continuous container, such as wash sink 10 of FIG. 1, from the bimetal laminate 12 (FIG. 2) by identifying, designing, and controlling certain specific variables in the properties of the metal-polymer-metal laminate 12. There are four primary variables that are critical to forming a laminated container: (1) the thickness ratio between the first and second constraining layers 30, 32, (2) the yield strength ratio between the first and second constraining layers 30, 32, (3) the springback force ratio between the first and second constraining layers 30, 32, and (4) the adhesion strength of the adhesive layer 34 to overcome the springback force ratio, as defined in (3) above. The thickness ratio, yield strength ratio, springback ratio, and adhesion strength are collectively engineered to thereby eliminate substantially all cracking and delamination of the laminate panel 12 during any subsequent metalworking, such as deep drawing.

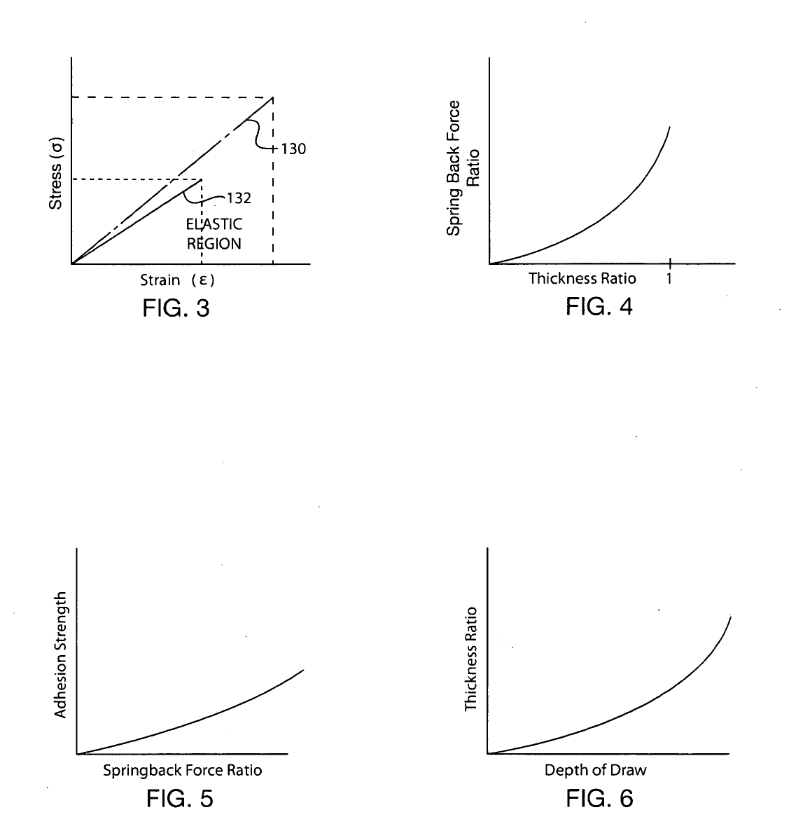

FIG. 3 is a graphical representation of the stress ((σ) versus (ε) strain curves for the first and second constraining layers 30, 32 of the laminate structure 12, respectively indicated at 130 and 132. That is, FIG. 3 overlays two different stress-strain curves for two different materials—the stainless steel utility layer and the low-carbon steel substrate, which have been adhesively bonded together, but measured and graphed individually. Stainless steel and low-carbon, deep draw quality steel exhibit both elastic and plastic deformation tendencies. Tested individually and plotted together, the curves for the first and second constraining layers 130, 132 will display different values for the two regions of elastic and plastic deformation.

When the sheet metal constraining layers are forming, the stretching is referred to as engineering strain, which is illustrated along the horizontal axis of the stress-strain chart of FIG. 3. As the metal is strained, it resists deformation by reacting with stress against the forming apparatus, which is illustrated along the vertical axis in FIG. 3. Once the die, representing the shape of the wash sink, is fully closed, the forming strain and stress in the individual layers can be measured. With the die fully closed under the force needed by the press to form the container, the panel and tool have roughly the same geometry. As the die is opened, any stresses in the laminate will relax—i.e., the stress level in the laminate will return to zero, following the stress-strain path line along the slope defined by the Young's Modulus (E) of each of the individual layers contained in the laminate. Ideally, the yield strength ratio between the first and second constraining layers 30, 32 is approximately 1:0.556.

The springback for the individual constraining layers is the amount of strain returned to the part as the stress returns to zero. Springback can be estimated with this formula: e_{sb}=S/E, where S is the forming stress and E is the Young's Modulus. For each of the individual layers of the laminate 12, the springback strain e_{sb} will be different and, thus, becomes the basis of understanding the springback force ratio, which is dependent upon the thickness ratio between the two different layers.

FIG. 4 is a graphical representation of the relationship between thickness ratio and springback force for the two constraining layers 30, 32. Specifically, the springback force ratio graph plots a non-linear curve based on the thickness relationship between two materials, such as stainless steel and low-carbon steel, that exhibit different elastic and plastic deformation tendencies. While the springback ratio at a particular location is not easily determined, proxy springback can be used to determine the overall springback force ratio between the two different constraining layers.

To determine the proxy stress for each of the individual layers, the forming stress (S) is simplified by assuming that all parts must be stressed beyond their yield point: S≧YS, therefore e_{sb}=YS/E. This then allows for a springback strain giving the springback strain ratio between the two materials. For instance, a part with an expected yield strength of 210 megapascals (MPa), the minimum springback response is found to be one millimeter per meter of sheet length. Ideally, the springback ratio between the first and second constraining layers 30, 32 is approximately 1:8.54.

When bending is the primary mode of deformation, the strain through the metal's thickness is more important. That is, as the part is bent, it undergoes various degrees of tensile and compressive modes of deformation through the thickness. As a result of the springback, the outer fibers of the material, which are formed under tension, shrink, while the inner fibers expand, causing the flange wall to open outward.

The forming stress difference between the two substrates is based on thickness. As the curve in FIG. 4 demonstrates, the springback ratio approaches a maximum value as the two constraining layers reaches a 1:1 thickness ratio, but declines greatly with dissimilar thicknesses. In the preferred embodiment presented in FIG. 2, the thicknesses ratio T1:T2 between the first and second constraining layers 30, 32 is approximately 1:4.75. It may not be possible, however, to eliminate springback variations between the two metallic materials by manipulating the thickness ratio alone. The strength of the bonding adhesive (e.g., adhesive layer 34) must also be considered to keep the two layers together during and after the forming process (e.g., creating wash sink 10).

FIG. 5 presents a curve based on the adhesion strength required to overcome the springback ratio differences between the two materials, and thus prevent separation, delamination, bubbling, etc. of the two constraining layers, allowing for a successfully formed wash sink. The greater the springback force difference between the two constraining layers, the greater need for a stronger adhesive. Ideally, the adhesive strength of the adhesive layer is at least 1200 pounds per square inch (psi).

FIG. 6 presents a curve marking the relationship between the maximum stainless steel to cold rolled steel thickness ratio required to successfully draw to the predetermined depth D of the sink 10 without the laminate structure 12 breaking or cracking. The ability for sheet metal to be successfully formed (e.g., drawn) without breaking is limited by the sheet metal thickness and “n-value” (also referred to in the art as “strain hardening exponent”). The “n-value” relates to the ability of a sheet metal material to be stretched in metalworking operations. The higher the n-value, the better the formability (e.g., “stretchability”). Given that both constraining layers 30, 32 will exhibit varying grades of formability, or n-values, success in forming is dependant the thickness of the thinnest substrate, i.e., first constraining layer 30, or the combined thickness ratio of both the first and second constraining layers 30, 32.

By understanding the mechanical properties of the individual constraining layers—e.g., through the stress-strain curve of FIG. 3, calculating the springback force ratio, as represented in FIG. 4, selecting a proper adhesion strength, as indicated in FIG. 4, understanding material thickness limitations to the depth of the bowl 14, and minimizing the springback force ratio by properly setting the thickness ratio, the metal-polymer-metal laminate 12 is capable of forming very deep, single continuous containers with a durable stainless steel surface.

A method of manufacturing a wash sink is also presented herein. In general, the method comprises first applying a layer of adhesive to the first constraining layer, the second constraining layer, or both. The next step includes laminating the first constraining layer to the second constraining layer to form a one-piece laminate panel. Thereafter, the method includes forming the laminate panel, preferably through deep drawing, to include at least one basin or bowl with a predetermined depth. The first and second constraining layers have a thickness ratio, yield strength ratio, and springback ratio that are engineered, along with the adhesion strength of the adhesive layer, to thereby eliminate substantially all cracking and delamination of the laminate panel during forming of the basin(s).

While the preferred embodiments and best modes for carrying out the present invention have been described in detail hereinabove, those familiar with the art to which this invention pertains will recognize various alternative designs and embodiments for practicing the invention within the scope of the appended claims.

1. A laminate structure, comprising:
a first constraining layer having a first thickness and formed at least partially from a first metallic material;
a second constraining layer having a second thickness greater than said first thickness, and formed at least partially from a second metallic material different from said first metallic material; and configured
an adhesive layer bonding said first and second constraining layers;
wherein said first and second constraining layers have a springback ratio that is optimized such that the laminate structure can be formed to define a depression of a predetermined depth without at least partially delaminating.

2. The laminate structure of claim 1, wherein said first and second constraining layers have a thickness ratio, a yield strength ratio, and said springback ratio that are collectively optimized such that the laminate structure can be formed to define said depression of predetermined depth without at least partially delaminating.

3. The laminate structure of claim 1, wherein said springback ratio is approximately 1:8.5.

4. The laminate structure of claim 1, wherein said first and second thicknesses have a thicknesses ratio of approximately 1:4.8.

5. The laminate structure of claim 1, wherein said first and second constraining layers have a yield strength ratio of approximately 1:0.6.

6. The laminate structure of claim 1, wherein said adhesive layer has an adhesive strength of at least 1200 psi.

7. The laminate structure of claim 1, wherein said predetermined depth is at least six inches.

8. The laminate structure of claim 1, wherein said first constraining layer consists essentially of stainless steel and said second constraining layer consists essentially of low-carbon steel.

9. The laminate structure of claim 1, wherein a total thickness of the laminate structure is less than 0.05 inches.

10. The laminate structure of claim 1, wherein said first constraining layer is characterized by at least one surface with an appearance finish, and said second constraining layer is characterized by the absence of a surface with an appearance finish.

11. A wash sink, comprising:
a laminate panel having a base with a plurality of sidewalls extending therefrom to collectively define at least one basin, the laminate panel including:
a utility layer having a first thickness and at least partially composed of a stainless steel material;
a substrate layer having a second thickness greater than said first thickness, and at least partially composed of a low-carbon cold rolled steel material; and
an adhesive layer disposed between and spanning substantially the entirety of said utility layer and said substrate layer to rigidly attach the same;
wherein said utility and substrate layers have a thickness ratio, a yield strength ratio, and a springback ratio that are collectively optimized to eliminate delamination of said laminate panel.

12. The wash sink of claim 11, wherein said springback ratio is approximately 1:8.54.

13. The wash sink of claim 11, wherein said yield strength ratio is approximately 1:0.56.

14. The wash sink of claim 11, wherein said thicknesses ratio is approximately 1:4.75.

15. The wash sink of claim 11, wherein said adhesive layer has an adhesive strength of at least 1200 psi.

16. The wash sink of claim 11, wherein said first thickness is approximately 0.008 inches, said second thickness is approximately 0.038 inches, and said adhesive layer has a third thickness of approximately 0.001 inches.

17. A method of manufacturing a wash sink, comprising:
applying a layer of adhesive to at least one of a first and a second constraining layer, said first constraining layer having a first thickness and at least partially composed of a stainless steel material, and said second constraining layer having a second thickness greater than said first thickness and at least partially composed of a cold rolled steel material;
laminating said first constraining layer to said second constraining layer to form a one-piece laminate panel; and
forming said laminate panel to define at least one basin having a predetermined depth;
wherein said first and second constraining layers have a thickness ratio, a yield strength ratio, and a springback ratio that are collectively optimized with an adhesive strength of said adhesive layer to thereby eliminate substantially all cracking and delamination of said laminate panel during said forming of said at least one basin.

18. The method of claim 17, wherein said springback ratio is approximately 1:8.54, said yield strength ratio is approximately 1:0.56, and said thicknesses ratio is approximately 1:4.75.

19. The method of claim 18, wherein said adhesive layer has an adhesive strength of at least 1200 psi.

20. The method of claim 19, wherein said forming said laminate panel includes deep drawing said laminate panel.
